(19) United States
(12) Patent Application Publication
(10) Pub. No.: US 2020/0158155 A1
(43) Pub. Date: May 21, 2020

(54) DEVICE FOR RETAINING A COMPONENT TO BE SECURED TO A SUPPORT PART, SYSTEM, AND USE OF A DEVICE FOR RETAINING A COMPONENT

(71) Applicant: A. Raymond et Cle, Grenoble (FR)

(72) Inventors: Ronnie Weissenfeld, Weil am Rhein (DE); Jessica VOLLMER, Zell im Wiesental (DE); Karl Bode, Lörrach (DE); Christoph Dägele, Algolsheim (FR)

(21) Appl. No.: 16/081,996

(22) PCT Filed: Mar. 2, 2017
(86) PCT No.: PCT/EP2017/000283

§ 371 Date: Sep. 4, 2018

(30) Foreign Application Priority Data
Mar. 4, 2016 (DE) 10 2016 002 583.2

(51) Int. Cl. F16B 21/08

(52) U.S. Cl. CPC F16B 21/086; B60R 13/0206

(57) ABSTRACT

The invention relates to a device for retaining a component to be secured to a support part, wherein the device comprises a plug element, having: a head, which is designed to be secured to the element, and a pin, which extends in a longitudinal direction from the head, wherein the pin can be inserted into an opening of the support part, and the pin has two anchor elements which extend radially from the pin, and the anchor element has a structure which is oriented substantially in the direction of the head.

The invention relates to a device for retaining a component to be secured to a support part, a system which comprises such a device, and a use of a device for retaining a component.

Clips with a variety of substantially flat bearing elements which can engage behind a support part are familiar as devices for retaining a component to be secured to a support part. Hence, the support part is engaged at several bearing points, which may render the fabrication of the clips more difficult, since bearing points or engaging points not lying in the same plane may be created in the specified tolerance range for the fabrication of the clips, such that a play may be created during the retaining of the element.

Therefore, the problem which the invention proposes to solve is to create a device for retaining a component to be secured to a support part which is easier to manufacture and/or which may allow larger tolerances.

The problem is solved by the subject matter of the coordinated claims. Advantageous embodiments are indicated in the dependent claims and the following specification.

The invention starts from the basic notion that the device comprises two anchor elements which engage behind the support part. The two anchor elements may bear against the support part and the choice of the number of two anchor elements ensures that precisely these two anchor elements will lie in the same plane. Two anchor elements result in a secure hold, wherein at least one of the anchor elements, preferably each of the anchor elements, has a latching structure (hereinafter called the structure) which is configured such that it is oriented substantially in the direction of the head and thus the support part, hearing against the anchor element in the installed state. This can improve the secure bearing and the secure hold.

The device for retaining a component to be secured to a support part comprises a plug element. The plug element comprises a head, which is designed to be secured to the component. Moreover, the plug element comprises a pin, which extends in a longitudinal direction from the head. The pin is designed to be inserted into an opening of the support part. The pin has two anchor elements which extend radially from the pin. At least one anchor element, preferably each anchor element, has a structure which is oriented substantially in the direction of the head. Thanks to the orientation of the structure in the direction of the head, the structure can be brought to bear against the support part. The structures of the anchor elements may define bearing points, which may lie substantially in the same plane, A floating bearing is possible for equalizing tolerances. A rattle-free firm seat with the least possible play can be realized. An acoustical decoupling is possible. It is also possible for the longitudinal extension of the device in the support part to not exceed roughly 20 mm, preferably 15 mm, so that a low structural height is achievable. Moreover, with this configuration, the previous design of other portions of the retention device, such as other special customer requirements, can be implemented as desired. The device may be configured as a single piece.

The term “retaining” of the component encompasses the suitability of the device to be connected to the component and in particular the suitability of the device, which may be fastened on a support part, to hold the component relative to the support part. In regard to the device connected to the support part, the term “retaining” encompasses the preventing of a movement of the component with respect to the support part in the area of the device, especially a movement along the pin axis of the device or that of the plug element in the area of the device in either direction.

The term “component” in the sense of the invention encompasses for example a panel or a component having a panel. The component may comprise a plate or a plate-shaped portion and in particular be used in the field of motor vehicle construction. For example, the component may be a protective strip, a wheel cover, a sill cover or the like for a motor vehicle.

The term “support part” in the sense of the invention encompasses a part of a motor vehicle. The support part may be a section of the chassis of the motor vehicle, a door or a wheel of the motor vehicle. The term “motor vehicle” in the sense of the invention encompasses a land vehicle, which can be moved by machine power, without being railbound.

The term “plug element” in the sense of the invention encompasses an element which can be fastened on the support part for its mounting or fastening, especially without a tool. A simple, toolfree mounting is possible, and in particular the possibility of automation exists, A rotation or a turning of the device is not necessary for the plugging in. Good process safety can be created. By means of the plug element, a low installing effort can be achieved, especially when inserting into an opening of the support part, which may lie in particular in the range of 50 to 85 N.

The term “head” denotes an end-side region of the plug element, which may define in particular the end region of the plug element. The head may be the end-side termination of the plug element. In the installed state, the head may be situated in the region of the component and/or extend at least partly through the component and be located on the outside of an opening formed in the support part, especially the component. The head in particular may comprise holding means, by which the head is secured to the component. The holding means may be fashioned in particular as clamping elements, so that the head can extend through an opening of the element and the clamping elements can hold the component in the direction of its thickness dimension.

The term “pin” in the sense of the invention comprises an elongated element, which may have the shape of a shaft. What is essential in the sense of the invention is the lengthwise extension, whereby the diameter or the contour of the pin perpendicular to its lengthwise extension is less than the extension in the longitudinal direction. The pin may assume any contour in the longitudinal direction, as long as not ruled out in the context of the invention. For example, the outer contour of the pin should be capable of being introduced through the opening on the support part, not ruling out an elastic deformation of the anchor elements and/or the pin, in order to insert the plug element through the opening of the support part.

The term “opening” in the sense of the invention encompasses a through hole, through which the plug element may extend such that the anchor elements can engage behind the rim of the opening. The “opening” may also be part of a stepped blind hole. The opening may have a diameter of roughly 5 mm to 15 mm, especially roughly 7 mm to 10 mm, most especially preferably 8.5 mm to 9.0 mm. The opening may be round, in particular circular.

The term “anchor element” in the sense of the invention encompasses an element by means of which the plug element can be fastened on the support part. The anchor element may engage behind the rim of the opening of the support part. The anchor elements may in particular be elastically deformable in the radial direction with respect to the pin. The anchor elements may be pressed through the opening and the elastic deforming may be substantially reversible and occur after the anchor element has passed through the opening. A certain portion of a plastic deformation may be technically necessary and is not ruled out. The anchor elements may comprise with the structure a bearing surface for engaging behind the opening. The anchor elements may be connected to the pin at a spring-loaded element, A spring force may pretension the anchor element in the direction away from the longitudinal axis of the pin. In one preferred embodiment, the respective anchor element stretches from the end of the pin facing away from the head back around in the direction of the head. In one preferred embodiment, the portions of the anchor elements provided at the end of the pin facing away from the head for a portion of a point at this end of the pin. In one preferred embodiment, the respective anchor elements at first stretch radially from the end of the pin facing away from the head and then pass around an arc into a portion of the respective anchor element which stretches in parallel with the longitudinal axis of the pin and back around in the direction of the head. In one preferred embodiment, the structure extending parallel to the longitudinal axis of the pin and back around in the direction of the head is provided at the head-side end of this portion of the respective anchor element. In one preferred embodiment, the anchor elements are situated on opposite sides of the pin.

The device may be configured as a clip. The anchor elements may be configured as “clip surfaces,” while a reduced clip surface is proposed according to the invention.

The term “structure” in the sense of the invention encompasses a structure which, owing to its shape under tensile loading, forms a bearing surface with the support part such that an adequate holding force is present and an equalizing of tolerances is possible.

The term “in the direction” as regards the mutual orienting encompasses in the sense of the invention the two elements facing each other. An orientation component is encompassed which is a line connecting the two elements referred to, not necessarily the shortest of the connecting lines. The term “in the direction” does not necessarily mean a direction merely situated on the line between the two elements.

Insofar as the term “a(n)” and corresponding grammatical adaptations to the gender of the elements denoted by the term in the specification and the claims is used, this term encompasses the singular and the plural case of the respectively denoted elements. The term “a(n)” and corresponding grammatical adaptations to the element denoted by the term generally does not rule out the providing of multiple elements. Insofar as a numerical statement is employed for a number, the designation of this number encompasses precisely this number, but also alternatively the same or a larger number of the respectively designated element.

In one preferred embodiment, the structure has a shape tapering in the direction of the head. In this way, the structure may form the smallest possible bearing surface against the support part. The smallest possible bearing surface may mean that different bearing points, not lying substantially in the same plane and formed on only one structure, can be avoided.

In one preferred embodiment, the tapering shape has a point, which is formed by at least two side surfaces, making an angle with the longitudinal direction of the pin. In this way, the bearing surface afforded by the structure for the support part can be reduced. The term “point” in the sense of the invention is not understood in the mathematical sense, but rather the term “point” encompasses a macroscopic real point. The term “side surface” in the sense of the invention encompasses surfaces which can subtend any given angle with the longitudinal direction of the pin. The side surfaces thus do not run parallel to the longitudinal direction of the pin. But it may also be provided that one of the side surfaces runs parallel to the longitudinal direction of the pin, while the other side surface which forms the point with the side surface running parallel to the longitudinal direction does not run parallel to the longitudinal direction of the pin. The structure may be formed substantially in a plane having a defined distance from the midpoint of the pin.

In one preferred embodiment, the structure of an anchor element tapers in a direction radially away from the pin, so that the edge of the opening can slide along the structure as the anchor element passes through. The introducing of the plug element can be improved in this way. A low installing force can be accomplished thanks to the structural configuration of the structure tapering in the radial direction. Low installing forces in the range of around 50 N to around 85 N can be achieved.

In one preferred embodiment, the device comprises a shield, situated centrally to the pin, in order to cover the opening formed on the support part and/or to support the device on the support part. The shield may be used as an abutment for the device in relation to the anchor elements. The support part and optionally the component being secured may be clamped between the shield and the anchor elements, Thus, the shield may cover the opening, especially from the margin of the pin, and produce a seal for the opening. Different degrees of sealing are possible, for example, a sealing against dust and/or water is possible. The shield may also be pretensioned in the direction of the support part in order to adjust a defined distance between the component and the support part. The term “in the direction” with respect to a movement or a pretensioning encompasses in the sense of the invention a movement having a directional component which is parallel to the direction. The term “in the direction” does not necessarily mean only a purely translatory movement in this one direction.

In one preferred embodiment, the head has a roof element, which is curved and has two operative lines which can be brought into contact with the element. It may be provided that the element with the plug element gets into an opening of the component by being forced into it. The roof element may engage behind the rim of the opening of the component. The plug element can be pre-installed with the component and the plug element together with the component can be fastened to the support part. The plug element in particular can be a bulk item which can be pre-installed. The final assembly with the support part can occur at a customer.

In one preferred embodiment, the pin is tapering at the end away from the head. Thanks to the tapering configuration, it is possible to simplify the installation; in particular, a blind installation is possible, in which the installer places the device in the region of the opening of the support part and uses the device as a search element or search point in order to introduce the device into the opening of the support part. In one especially preferred embodiment, the tapering configuration is substantially closed and/or substantially free of edges. A rounded and/or smooth configuration is preferred, which lessens the possibility of the device getting caught as it slides across the support part when searching for the opening.

Preferably, the device has a smooth configuration in the direction of the head, so that an inserting of the device into the opening of the support part or another opening—in the following, the opening of a bushing—is facilitated.

In one preferred embodiment, the device comprises a plastic. The term “comprise” in the sense of the invention also encompasses “consist of”, so that the device or the plug element consists of plastic. The use of a plastic affords the advantage that a corrosion-free installation is possible. Furthermore, with a suitable choice of the plastic, a chemical resistance, temperature resistance, and/or long service life is possible. Moreover, a device of low weight can be created, in particular, all requirements relevant for testing can be met (such as hydro pulse duration bench tests, car wash resistance, tightness tests, and climate and temperature storage tests). In particular, a thermoplastic material can be used for the plug element, especially a polyoxymethylene (POM) or polyamide (such as PA-66), and most particularly the copolymer POM-C. In particular, the plug element can be made by injection molding or extrusion or extrusion blow molding. An economical fabrication of the device can be realized in this way. The device can be made from a material as a single piece.

The device may lie with a part or element against the support part, for example, with the shield. For the protecting of the surface of the support part and/or for the sealing of the contact between support part and device, a sealing means arranged on the device can be provided. The sealing means may be designed as a single piece with the device. The sealing means may be formed separated or separately from the device. The sealing means is preferably adapted by a dimension to the device, for example the shield of the device. The sealing means may have, for example, an inner contour which is adapted to an outer contour of a portion of the device, such as the shield of the device. The sealing means may have an outer circumference and/or an outer contour which is adapted to the outer circumference and/or the outer contour of the shield.

The sealing means extends around the device, being preferably closed in the circumferential direction of the device, especially transversely to the longitudinal axis of the device. The sealing means may extend in a round shape around the device. A polygonal shape with straight segments is likewise possible, as is a mixed form of round and straight segments. The sealing means may be round or polygonal in cross section.

The sealing means may be positioned relative to the device or fixed to the device at positioning and/or fixation elements, which can be formed on the device. Alternatively or additionally, the sealing means can be arranged on a bushing of a system described below.

The sealing means can be arranged in a recess or seat of the shield. The shield may be adapted in its shape to the sealing means. The sealing means can be configured as an O-ring or some other suitable shape having substantially elastic material. The sealing means can be a largely closed-pore and elastic foam material, such as foam rubber. The sealing means may comprise an elastic, substantially closed plastic. The sealing means may be formed as a single piece with the device at the margin of the shield. The thickness or extension of the sealing means may be adapted to the position of the structure of the anchor element in the direction of the longitudinal axis of the device. When the anchor element engages behind the support part and/or a bushing, the sealing means is compressed and provides a sealing.

The invention also creates a system which comprises an aforementioned device. Moreover, the system comprises a bushing, having an inner contour which is adapted to the outer circumference of the device, especially the plug element, and having a bearing element for the anchor element.

The bearing elements comprise a bearing surface, which is formed substantially transversely to the longitudinal axis. When the bearing elements bear against the anchor elements, the relative movement of device and bushing with respect to each other in the direction of the longitudinal axis can be prevented. The bearing elements form a stopping or bearing surface for the anchor elements of the device in the direction of the longitudinal axis. The bearing elements are formed substantially complementary to the anchor elements. A recess is formed between the respective bearing surfaces for the side surfaces of the structure of the anchor element. The recess has a round circular shape. In this way, a possible tolerance or slight deviations during the manufacturing of the bearing surfaces and the complementary surfaces of the anchor element can be taken into account.

The term “bushing” in the sense of the invention encompasses a tubular part and/or a part having a tubular portion into which the plug element may be inserted. The hushing for its part may pass through the opening of the support part and be interlocked with the support part. If a bushing in the sense of the invention is present in the opening of the support part, the anchor elements during the assembly process can bear against the bearing elements of the bushing. The bushing may have an opening at both ends of the tubular part or tubular portion, and a passage may be formed between the openings.

The bushing in particular may have locking units in the form of retaining cams, with which the bushing is locked or latched in the support part.

Thanks to the use of a bushing, a defined opening can be provided for the plug element. The bushing in turn may equalize tolerances in the region of the opening of the support part. Moreover, the bushing may provide defined bearing elements for the anchor elements. The plug element may be formed independently of the opening on the support part, provided an adapting or an overlapping of a particular region is possible with the bushing. It is only necessary to adapt the plug element to the bushing. The dimensions of the device can be decoupled to a certain extent from the dimensions of the opening of the support part. The bushing may be adapted to the opening and/or the thickness of the support part, while the device in turn may be adapted to the dimensions of the bushing.

Preferably, the bushing has a smooth configuration in the direction of its shoving into the opening of the support part, so that a simple inserting of the bushing into the opening of the support part is possible.

In one preferred embodiment, the device comprises one or more orienting elements, while the bushing comprises one or more orienting elements, and the orienting element of the device and the further orienting element of the bushing are adapted to interact with each other in order to orient the device and the bushing to each other in a rotational relation. By the providing of orienting elements, a simplified (blind) installation can be created, during which an orienting of the parts coordinated with each other is done in such a way that they can only be joined together at a particular angle of rotation relative to each other. Thanks to the orientation in a rotational relation to each other, the anchor elements can be placed in a definite position and can interact accordingly with the bushing. For example, the orienting element may be configured on the device as a positioning rib and/or the other orienting element can be configured on the bushing as a groove. Preferably, the groove may have a broadened insert opening at one end for the positioning rib. The insert opening may be enlarged in the circumferential direction and/or enlarged in the radial direction with regard to the groove, in order to make possible an introducing in an angle range and/or in a region of a possible tilting of the device or the plug element relative to the bushing.

In one preferred embodiment, the device has one or more longitudinal and/or transverse ribs, which interact with the inner contour or the inner diameter of the bushing for a centering of the device in relation to the bushing and/or for adjusting a play between device and bushing.

In one preferred embodiment, the bushing comprises a cover, which is designed to cover the opening on the support part and/or to pretension the bushing in the longitudinal direction of the bushing in the opening. The cover can produce a seal, with different degrees of sealing being possible. For example, a tightness to dust may be achieved. A tightness to fluid may also be achieved, making provision for different fluids, gases or liquids.

In one preferred embodiment, the bushing has a depth end stop which is designed to limit the depth of insertion of the bushing in the opening, so that the bushing provides a standard for the device and defined conditions are present when installing the bushing in the opening of the support part. Thanks to the use of the depth end stop, a reference can be used to establish the distance between the top region of the bushing and the top side of the support part.

In one preferred embodiment, the bushing has radially extending ribs, which are designed to center the bushing in the opening of the support part. By a suitable choice of the material for the ribs, an adapting can be accomplished over a certain region of the opening diameter for the opening. The ribs can be compressed uniformly in order to provide a centering of the bushing in relation to the opening in the support part. With the ribs, it is possible to equalize tolerances in the area of the shape of the opening of the support part and/or in the area of the size of the opening of the support part. A centering can be done for example in regard to the center of gravity of the opening.

In one preferred embodiment, the bushing comprises a plastic. In the sense of the invention, the term “comprise” also encompasses the term “consist of”. The plastic may be, in particular, polypropylene (PP), polyoxymethylene (POM), polyamide (PA) or polyetheretherketone (PEEK), A corrosion-free installation is possible, chemical resistance, temperature resistance, and/or long service life can be achieved by a suitable choice of the plastic. In particular, all requirements relevant for testing can be met (such as hydro pulse duration bench tests, car wash resistance, tightness tests, and climate and temperature storage tests). The material of the bushing, especially the tubular portion of the bushing, preferably has a certain strength, in order to form a defined opening, into which the device or the plug element can be inserted. Preferably, the material of the bushing, especially at least the material of the tubular portion of the bushing, is a thermoplastic or thermosetting material.

The system can be pre-installed with the component. For example, the device together with the bushing secured to the device may be pre-installed on a component, especially one configured as a panel. In this way, the final installation can be reduced to one installation step, where the device together with the bushing and the component fastened to the device can be fastened by a single inserting step on the support part.

Accordingly, the installation can be done in two steps: at first, the bushing can be fastened to the device. Then the device on which the component is fastened can be fastened to the bushing or the support part by means of an inserting step. However, the installation can also be done in a single step on the support part.

The invention may also create a method for the mounting of a component to be retained on a support part in the motor vehicle industry, wherein a system secured to a component and comprising a device and a bushing is fastened in one step to the support part, especially by means of inserting the (pre-mounted) assembly comprising the component, the device, and the bushing, into an opening of the support part.

In one preferred embodiment, the bushing can remain in the support part in event of a dismounting of the component. The component can be removed from the support part. In one especially preferred embodiment, a dismounting can be accomplished by applying a force of roughly 130 N to roughly 200 N. The dismounting force can be adjusted through an angle of the structure. For example, the dismounting force can be adjusted by means of a point formed on the structure or an angle of radially outward descending surfaces formed on the structure. Especially preferably, the bushing remains on the support part and the component on the device. In this way, a nondestructive dismounting of the device is assured for purposes of servicing if the dismounting forces of the device are smaller than the dismounting forces of the bushing.

The invention also creates a use of a device for retaining a component which is to be secured to a support part comprising a plug element. The plug element has a head, which is designed to be secured to the component. Moreover, the plug element has a pin, which extends in a longitudinal direction from the head, wherein the pin can be inserted into an opening of the support part. Two anchor elements are used, which extend radially from the pin and have a shape which extends substantially perpendicular to the longitudinal axis of the pin, while the shape has a structure pointing toward the head.

The invention shall be explained more closely below with the aid of drawings which show the embodiments of the invention. There are shown:

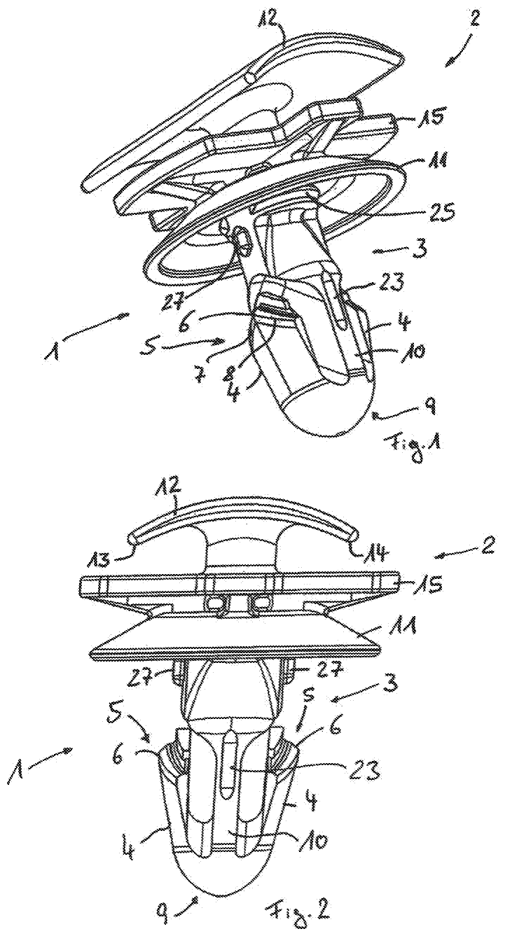

FIG. 1 an isometric view of a device according to the invention slanting from below;

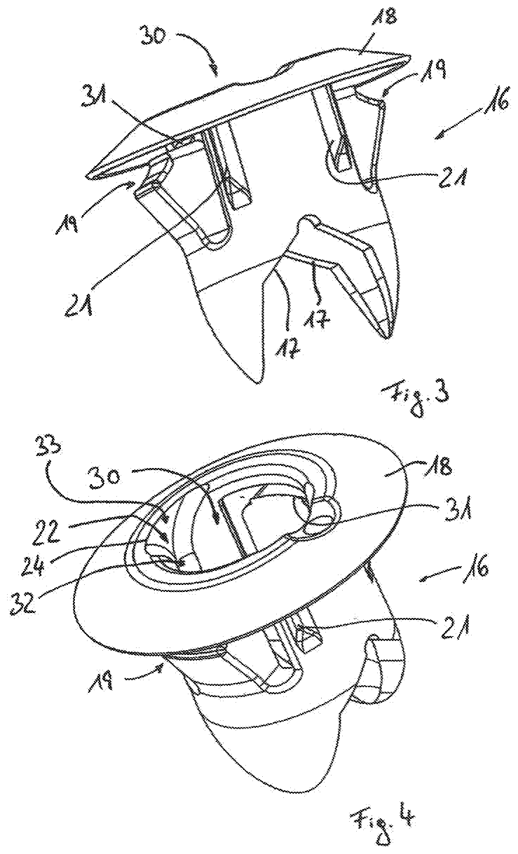

FIG. 2 a side view of the device of FIG. 1;

FIG. 3 an isometric view of a bushing according to the invention slanting from the side;

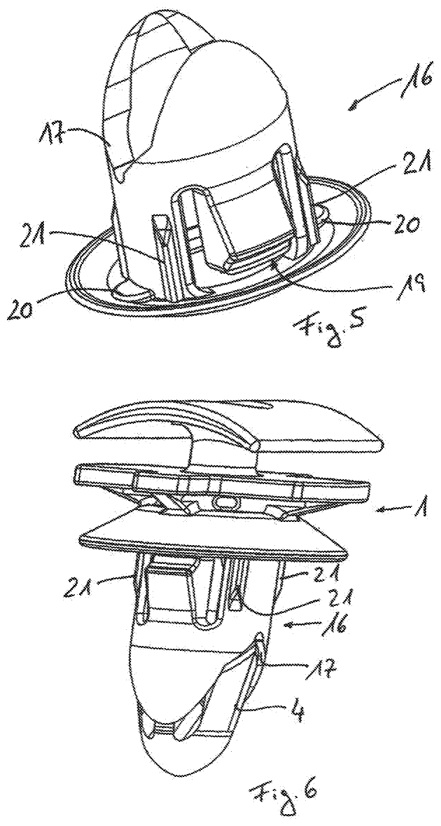

FIG. 4 an isometric view of the bushing of FIG. 3 slanting from above;

FIG. 5 an isometric view of the bushing of FIG. 3 slanting from below;

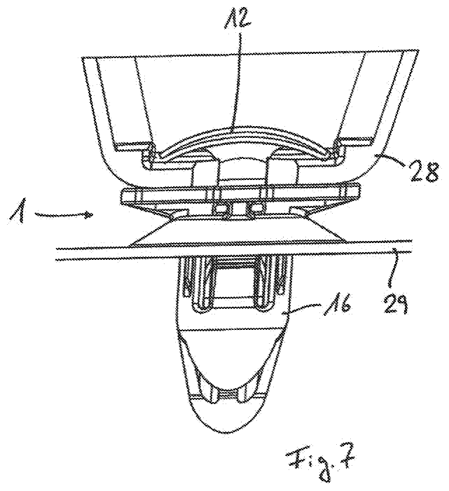

FIG. 6 an isometric view of the device of FIG. 1 and the bushing of FIG. 3 in an inserted state;

FIG. 7 a cross sectional representation from the side of the device and bushing of FIG. 6 with fastened component and fastened support part;

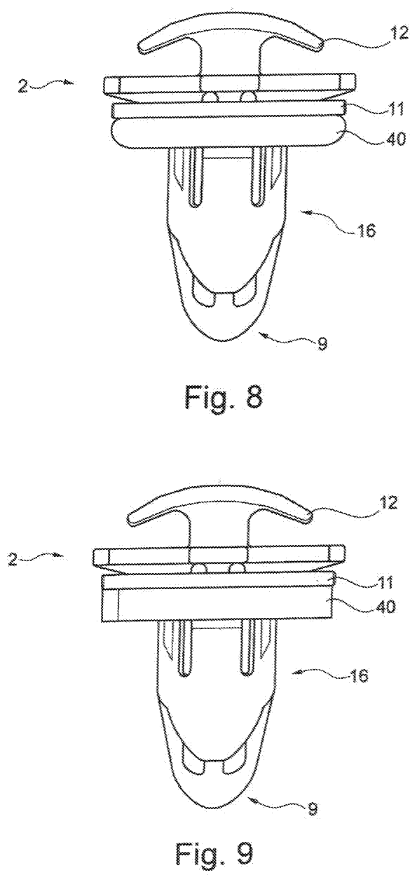

FIG. 8 a side view of a system in a further embodiment;

FIG. 9 a side view of a system in a further embodiment; and

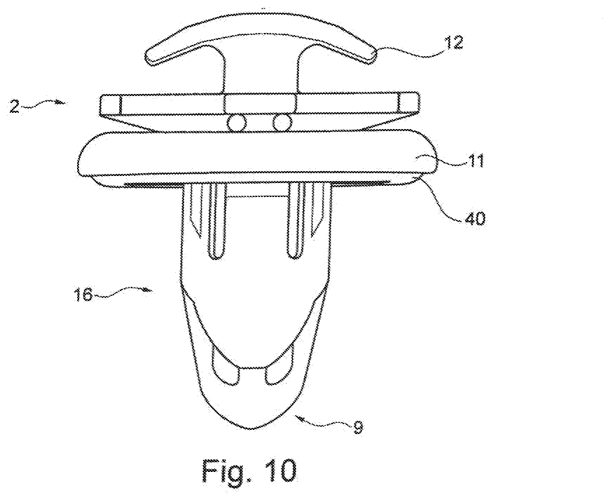

FIG. 10 a side view of a system in a further embodiment.

FIGS. 1 and 2 show an isometric view of a device 1 according to the invention. The device 1 comprises a head 2 and a pin 3, The pin 3 extends in a longitudinal direction from the head 2. The pin 3 comprises two anchor elements 4 which extend radially from the pin 3. Each of the anchor elements 4 has a structure 5 which points substantially in the direction of the head 2. The structure 5 has a shape tapering in the direction of the head 2.

In the sample embodiment shown in FIGS. 1 and 2, the tapering shape of the structure 5 has a point 6 which is formed by two side surfaces 7, 8, making an angle with the longitudinal direction of the pin 3. The structure 5 is formed symmetrical in the sample embodiment shown in FIGS. 1 and 2 by the side surfaces 7, 8 running symmetrically to the pin axis.

The structure 5 of the anchor elements 4 tapers in a direction radially away from the pin 3. The structure 5 descends from the direction of the roof 2 of the device 1 to the end 9 of the device 1 facing away from the roof 2. The end 9 from which the anchor elements 4 extend in the direction of the head 2 is formed smooth and closed.

The anchor elements 4 of the device extend respectively from two webs 10, which are formed symmetrically in the circumferential direction of the pin 3, The anchor elements 4 are formed rotationally symmetrical and symmetrical to the pin 3.

The device comprises a shield 11, arranged centrally to the pin 3 and pretensioned in the direction of the anchor elements 4 or the end 9. The shield 11 is centered in the form of a circle around the pin 3. The shield 11 extends in closed manner around the pin 3, The shield 11 is formed with point symmetry about the midpoint of the pin 3 and has a bearing surface at its rim for a support part. The shield 11 may be dimensioned such that it covers an opening of the support part.

On the head 2 of the device 1 is formed a roof element 12, which is curved. The roof element 12 comprises two operative lines 13, 14, between which and an abutment 15 a component can be clamped.

FIG. 3, 4, 5 show a bushing 16 for a system according to the invention. The bushing 16 comprises an inner contour, which is adapted to the outer circumference of the device 1. The bushing 16 comprises a bearing element 17 for the anchor element 4 of the device 1. The bearing elements 17 of the bushing 16 abut against the anchor elements 4 of the device 1 when the device 1 is shoved into the bushing 16.

The bearing element 17—as can be seen in FIG. 3—comprise a bearing surface which is formed substantially transversely to the longitudinal axis. If the bearing elements 17 abut against the anchor elements 4, the relative movement of device 1 and bushing 16 with respect to each other in the direction of the longitudinal axis is prevented. The bearing elements 17 form a stopping or bearing surface for the anchor elements 4 of the device in the direction of the longitudinal axis. The bearing elements 17 are fashioned substantially complementary to the anchor elements 4. Between the respective bearing surfaces for the side surfaces 7, 8 of the structure 5 of the anchor element 4 there is formed a recess—which is especially visible in FIGS. 3 and 4. The recess has a round circular shape.

The bushing 16 comprises a cover 18, arranged at the head end. The bushing 16 can be latched to a support part 29 between the cover 18 and a locking shoulder 19. The bushing 16 forms a predefined opening or a predefined passage 30 for the device 1.

For a nondestructive dismounting of the bushing 16, the bushing 16 comprises a lug 31, which is formed on the locking lug 19 and can be accessed through the opening 30 of the bushing 16. The lug 31 can be used to loosen the locking lug 19 from its locking position. The unlocking can be done, e.g., with a tool such as a screwdriver, by engaging the screwdriver in the opening 30 of the bushing 16 and behind the lug 31, and then tilting the lug 31 inward to loosen the locking of the locking lug 19 to the support part 29.

Depth end stops 20 are distributed on the bushing 16 in the circumferential direction at equal angles, and they can limit the depth of insertion of the bushing 16. The bushing 16 has ribs 21 extending radially from the bushing, being arranged at equal angles on the circumference of the bushing.

The bushing 16 comprises orienting elements 22 in the form of insert openings 33 and grooves 32, which interact with orienting elements 27 of the device 1 in the form of positioning ribs. The bottom of the groove 32 (depth of the groove) and the sides of the groove 32 (width of the groove) are adapted to the dimensions of the positioning rib in height and width. The two bottoms of opposing grooves 32 in the bushing 16 have a spacing substantially corresponding to the spacing between the positioning ribs. In the region of the insert opening 33, the spacing between the bottoms of the grooves 32 is enlarged, so that the bottom of the insert opening 33 at the end-side region of the bushing 16 has an enlarged distance from the middle of the bushing 16. In the region of the insert opening 33, the spacing between the sides of the grooves 32 is enlarged, so that the sides of the insert opening 33 at the end-side region of the bushing 16 have an enlarged—maximum—spacing from each other in the area of the cover 18.

The device 1 comprises longitudinal ribs 23 for a centering with respect to the inner diameter of the bushing 16, by which a play can be defined between device 1 and Bushing 16.

The device 1 comprises transverse ribs 25 for a centering with respect to the inner diameter of the bushing 16.

FIG. 6 shows the device 1 in a state in which it has been shoved into the bushing 16, The anchor elements 4 lie by their structure 5 against the bearing elements 17 of the bushing 16.

FIG. 7 shows how the device 1 according to the invention is fastened to a component 28 at the head 2. The component 28 is clamped between the roof element 12 and the abutment 15, The device 1 is inserted into the bushing 16, which is locked on a support part 29, by means of the locking shoulder 19.

In the following, three further embodiments of a system according to the invention shall be described, where the sole difference from the previously described system is the providing of a sealing means 40. The device 1 and the bushing 16 may be configured as described above, and only an adapting to the sealing means 40 needs to be done (see FIG. 10).

FIG. 8 shows a side view of another system in which a sealing means 40 is provided in order to seal off the abutment of the device 1 against the support part 29, not shown (see FIG. 7). The sealing means 40 is configured as an O-ring, which is adapted by its diameter to the diameter of the shield 11. The outer diameter of the sealing means 40 is substantially identical to the diameter of the shield 11. The contact regions between shield 11 and sealing means 40 lie at a distance from the edge of the shield 11. The sealing means 40 can be positioned relative to the device 1 and/or fixed in the radial direction or transversely to the longitudinal axis of the device 1 by means of positioning elements on the device and/or the bushing 16.

FIG. 9 shows a side view of another system in which a sealing means 40 is provided in order to seal off the abutment of the device 1 against the support part 29, not shown (see FIG. 7). The sealing means 40 is configured as a round gasket, having an outer diameter corresponding to the outer diameter of the shield 11. The cross section of the sealing means 40 is substantially rectangular. The sealing means 40 can be positioned relative to the device 1 and/or fixed in the radial direction or transversely to the longitudinal axis of the device 1 by means of positioning elements on the device and/or the bushing 16.

FIG. 10 shows a side view of another system in which a sealing means 40 is provided in order to seal off the abutment of the device 1 against the support part 29, not shown (see FIG. 7). The shield 11 is at least partly aftermolded on the sealing means and the sealing means 40 lies at least partly against the circumference of the shield 11. The sealing means 40 is at least partly surrounded by the shield 11 on the circumference and the sealing means is retained on the shield 11. The sealing means 40 is configured as an O-ring.

1. A device for retaining a component to be secured to a support part, wherein the device comprises a plug element, having:
a head, and
a pin, which extends in a longitudinal direction from the head, the pin having two anchor elements which extend radially from the pin, and at least one anchor element has a structure oriented substantially in the direction of the head.

2. The device as claimed in claim 1, wherein the structure has a shape tapering in the direction of the head.

3. The device as claimed in claim 2, wherein the tapering shape has a point formed by at least two side surfaces, making an angle with the longitudinal direction of the pin.

4. The device as claimed in claim 1, wherein the structure tapers in a direction radially away from the pin.

5. The device as claimed in claim 1, wherein the device comprises a cover, situated centrally to the pin, the cover covering the opening of the support part.

6. The device as claimed in claim 1, wherein the pin tapers at the end away from the head.

7. The device as claimed in claim 1, wherein the device is formed from a plastic.

8. A system comprising the device as claimed in claim 1, moreover comprising a bushing having an inner contour adapted to the outer circumference of the device and having a bearing element for the anchor element.

9. The system as claimed in claim 8, wherein the device comprises one or more orienting elements and the bushing comprises one or more orienting elements, wherein the orienting element and the further orienting element are adapted to interact with each other in order to orient the device and the bushing to each other in a rotational relation.

10. The system as claimed in claim 8, wherein the device has one or more ribs selected from the group consisting of at least one longitudinal rib and at least one transverse rib, which interact with the inner contour of the bushing for a centering of the device in relation to the bushing.

11. The system as claimed in claim 8, wherein the bushing comprises a cover to cover the opening and to pretension the bushing in the longitudinal direction of the bushing.

12. The system as claimed in claim 8, wherein the bushing has a depth end stop to limit the depth of insertion of the bushing in the opening.

13. The system as claimed in claim 8, wherein the bushing has radially extending ribs to center the bushing in the opening.

14. The system as claimed in claim 8, wherein the bushing is formed from a plastic.

15. The system as claimed in claim 8 with a component for a motor vehicle and a support part of a motor vehicle.

16. A use of a device for retaining a component which is to be secured to a support part, comprising a plug element having:
a head, which is designed to be secured to the element and
a pin, which extends in a longitudinal direction from the head, wherein the pin can be inserted into an opening of the support part,
characterized in that at least two anchor elements are used, which extend radially from the pin, and at least one anchor element has a shape which extends perpendicular to the longitudinal axis of the pin, and comprises a structure pointing toward the head.

17. The device as claimed in claim 1, wherein the device comprises a cover, situated centrally to the pin, the cover supporting the device on the support part.

18. The device as claimed in claim 2, wherein the structure tapers in a direction radially away from the pin.

19. A system comprising the device as claimed in claim 2, and moreover comprising a bushing having an inner contour adapted to the outer circumference of the device and having a bearing element for the anchor element.

20. The system as claimed in claim 8, wherein the device has one or more ribs selected from the group consisting of at least one longitudinal rib and at least one transverse rib which interact with the inner contour of the bushing for adjusting play between device and bushing.
